(19) United States
(12) Patent Application Publication
(10) Pub. No.: US 2005/0260547 A1
(43) Pub. Date: Nov. 24, 2005

(54) Method, apparatus, computer program product, and system for aiding in literacy

(76) Inventor: Don Moody, New York, NY (US)

Correspondence Address: TOPE-MCKAY & ASSOCIATES, 23852 PACIFIC COAST HIGHWAY #311, MALIBU, CA, 90265, US

(21) Appl. No.: 10/850,186

(22) Filed: May 19, 2004

(51) Int. Cl. G09B 1/00

(52) U.S. Cl. 434/176; 434/159

(57) ABSTRACT

A technique for aiding in literacy development is presented. The technique includes an apparatus, method, system, and computer program product using Word Things to build on a foundation of language development and bring users (e.g., children) toward a world of literacy. The Word Things are comprised of a set of linguistic characters formed such that when the linguistic characters are arranged to form a word, the word forms a shape representative of an object represented by the word. In animated versions, the Word Things interact in a Word World environment, making letters, phonics and words come alive in a new and unique way by giving them a physicality that enhances appeal and comprehension.

### BACKGROUND OF INVENTION

(1) Field of Invention

The present invention relates to a technique for bridging character acquisition and early reading skills and, more specifically, to an apparatus, method, system, and computer program product for using a set of characters to form a word, such that when the characters are arranged to form a word, the word forms a shape representative of an object represented by the word.

(2) Description of Related Art

For several decades, experts have debated how best to teach children to read. Until the 1980s, most students acquired basic literacy by learning letters, letter sounds, letter combinations, word constructs and word construction. This approach, known commonly as phonics, is generally taught through the discrete skills that make up reading and direct, sequential teaching methods that evolved from this style.

In contrast, the whole language approach, which came into popular use in the 1980s and 1990s, is based on the assumption that children learn a whole word first, develop an understanding of the word, and then extrapolate a “hypothesis” regarding how oral and written language operates. According to this system, children learn best when they decode the word within its context, ideally in an authentic literary experience rather than in basal readers.

Researchers and educators now agree that a combination of these two methods (i.e. phonics, and whole language approaches) is the best way to teach children to read, write, and foster a positive attitude toward literacy. Therefore, it can be appreciated that there exists a continuing need for a new and improved teaching technique that combines the benefits of both the phonics and whole language approaches. The present invention substantially fulfills this need.

### SUMMARY OF INVENTION

The present invention relates to an apparatus for aiding in literacy development. The apparatus comprises a set of linguistic characters formed such that when the linguistic characters are arranged to form a word, the word forms a shape representative of an object represented by the word; thereby assisting a user in bridging letter acquisition and reading skills, thereby aiding in literacy development.

The linguistic characters are selected from a group consisting of Chinese characters, Japanese characters, and letters to be used in forming words. The shape formed is a shape selected from a group consisting of an animal, a plant, a vehicle, a dwelling, an icon, a cartoon character, and an object.

Furthermore, the set of linguistic characters is formed on a substrate, and the substrate is selected from a group consisting of a book, blocks, a puzzle, a toy, and a multi-sided flash card. Additionally, at least two linguistic characters in the set of linguistic characters are detachably attached with each other through a connector. The connector is selected from a group consisting of magnets, locking shapes, Velcro, snaps, and zippers.

Additionally, a sound actuator is connected with at least one linguistic character in the set of linguistic characters. Furthermore, an activator is operably connected with the sound actuator to produce a stored sound. The stored sound corresponds with a sound representative of the at least one linguistic character.

In another aspect, when the linguistic characters are arranged to form a word, the activator is actuated to activate the means for storing and reproducing a stored sound. The stored sound in this aspect is a sound selected from a group consisting of a sound being representative of the word, a sound being representative of a sound made by an object representative of the word, and a theme song.

In another aspect, the present invention relates to a method for making and using linguistic character based shapes to aid in literacy development. The method comprises an act of forming a plurality of linguistic characters in a particular shape such that when the plurality of linguistic characters are arranged alongside each other to form a word, the word forms a shape representative of an object represented by the word; thereby assisting a user in bridging letter acquisition and reading skills, thereby aiding in literacy development.

The act of forming a plurality of linguistic characters further comprises an act of selecting a linguistic character from a group consisting of Chinese characters, Japanese characters, and letters to be used in forming words; and forming a shape, the shape selected from a group consisting of an animal, a plant, a vehicle, a dwelling, a cartoon character, and an object.

The method further comprises an act of generating a Word World episode, the Word World episode being a fictitious environment where at least one word thing is present. Furthermore, the episode is provided for a duration of time, the duration of time being from approximately one minute to thirty minutes.

In the act of generating a Word World episode, the episode is an animated episode where the word things are animated and take the shape of an object; the episode is a narrative that relates an event and forms a coherent story in itself; and the episode is generated in a format selected from a group consisting of a television show story line, a book story line, a computer game story line, a puzzle pictorial, and an Internet-based interactive web-site story line.

In another aspect, the method further comprises an act of generating visual clues and a narrative to assist the user in garnering a meaning of the word thing.

Additionally, the act of generating a Word World episode further comprises an act of generating a problem in the episode, where the word things interact with each other to solve the problem; an act of encouraging viewers to help solve the problem by encouraging the viewer to call out letters; an act encouraging viewers to repeat letter sound combinations; an act of generating a karaoke recap near the end of each episode, thereby providing a chance for viewers to revisit key words, which are visually highlighted in the karaoke recap; an act of generating a story line where the word things collide, connect, come apart, and gain or lose letters to form new words; and an act of generating a build a word song, the build a word song corresponding to contents of a particular episode in which the build a word song is generated. Furthermore, the animated word things construct and reconfigure words to solve the problem.

In another aspect, the method comprises an act of generating a take-away word, the take-away word being a word that is emphasized and revisited throughout the episode so that a viewer can develop a solid familiarity with the take-away word.

Additionally, the method further comprises an act of recording the Word World episode; and an act of broadcasting the Word World episode.

As can be appreciated by one in the art, the present invention is not limited to an apparatus and method, but can also be incorporated into other aspects such as a data processing system and a computer program product. The other aspects can be configured to be internet accessible and to perform all of the acts of the method described herein.

### BRIEF DESCRIPTION OF THE DRAWINGS

The objects, features and advantages of the present invention will be apparent from the following detailed descriptions of the various aspects of the invention, taken in conjunction with reference to the following drawings, where:

FIG. 1 is an illustration of a Word Thing according to the present invention;

FIG. 2 is an illustration of a Word Thing according to the present invention;

FIG. 3 is an illustration of a Word Thing according to the present invention;

FIG. 4 is an illustration of a Word Thing according to the present invention;

FIG. 5 is an illustration of a Word Thing according to the present invention;

FIG. 6 is an illustration of a Word Thing according to the present invention;

FIG. 7 is an illustration of a Word Thing according to the present invention;

FIG. 8 is an illustration of a Word Thing according to the present invention;

FIG. 9 is an illustration of a Word Thing according to the present invention;

FIG. 10 is an illustration of a Word Thing with un-connected and connected linguistic characters according to the present invention;

FIG. 11 is an illustration of a flash card according to the present invention;

FIG. 12 is an illustration depicting a system for using linguistic characters to form words to aid in literacy development according to the present invention;

FIG. 13 is a block diagram of a general computer system for use with the present invention; and

FIG. 14 is an illustrative diagram of a computer-readable medium aspect of the present invention.

### DETAILED DESCRIPTION

The present invention relates to a technique for bridging character acquisition and early reading skills, and more specifically, to an apparatus, method, system, and computer program product for using a set of linguistic characters to form a word, such that when the linguistic characters are arranged to form the word, the word forms a shape representative of an object represented by the word.

The following description, taken in conjunction with the referenced drawings, is presented to enable one of ordinary skill in the art to make and use the invention. Various modifications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

In order to provide a working frame of reference, first a glossary of terms used in the description and claims is given as a central resource for the reader. Second, a discussion of various principal aspects of the present invention is provided. Third, an introduction is presented to provide the reader with a broad understanding of the present invention. Fourth, a discussion is provided to give an understanding of the specific details of the present invention. Finally, a conclusion is provided to summarize key aspects of the present invention.

(1) Glossary

Before describing the specific details of the present invention, a centralized location is provided in which various terms used herein and in the claims are defined. The glossary provided is intended to provide the reader with a general understanding for the intended meaning of the terms, but is not intended to convey the entire scope of each term. Rather, the glossary is intended to supplement the rest of the specification in more clearly explaining the terms used.

Episode—The term “episode” refers to a portion of a narrative that relates an event or a series of connected events and forms a coherent story in itself, non-limiting examples of which include a television show story line, a book story line, a computer game story line, and a puzzle pictorial.

Means—The term “means” as used with respect to this invention generally indicates a set of operations to be performed on a computer, and may represent pieces of a whole program or individual, separable, software modules. Non-limiting examples of “means” include computer program code (source or object code) and “hard-coded” electronics (i.e. computer operations coded into a computer chip). The “means” may be stored in the memory of a computer or on a computer-readable medium such as a floppy disk, a CD-ROM, and a flash drive.

Word Thing—The term “Word Thing” refers to a word comprised of a plurality of linguistic characters, such that when the linguistic characters are arranged to form the word, the word forms a shape representative of an object represented by the word, non-limiting examples of which include an animal, a plant, a vehicle, a dwelling, an icon, a cartoon character, and an object.

Word World—The term “Word World” refers to a fictitious world where Word Things are present and interact with each other. The Word World may contain any number of Word Things, but no less than one Word Thing.

(2) Principal Aspects

The present invention has four “principal” aspects. The first is an apparatus for providing a user with tools needed to form a Word Thing. The second principal aspect is method for making and using a Word Thing, typically in the form of animation, software and/or manual operations. The third principal aspect is data processing system for using linguistic characters to form words to aid in literacy development, typically in the form of software and/or manual operations, operated using a data processing system (computer). The fourth principal aspect is a computer program product. The computer program product generally represents computer-readable code (either source or object code) stored on a computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read only memory (ROM), and flash-type memories. These aspects will be described in more detail below.

(3) Introduction

Individuals learn to read through a non-linear process that begins as play. For example, children hold, touch and taste board books and toy letters before they are able to assign meaning to them; they “read” to their parents or stuffed animal, occasionally holding the book upside down or backwards; and they write notes that look to adults like squiggles. These activities are the earliest form of emergent literacy, the precursor to more conventional literacy acquisition in which children are introduced to letters and taught to read.

The present invention lies between these two stages, providing techniques that bridge letter acquisition and reading skills. Based on cognitive research that indicates that learning is most effective when it allows the learner to participate through constructive play, the present invention prepares emergent readers for conventional reading instruction. Utilizing a user's (e.g., child's) natural desire to play with toys, letters, words, and books, the present invention aims to initiate the reading process by providing opportunities for children to manipulate, build, and interact with letters, sounds and words in a playful manner.

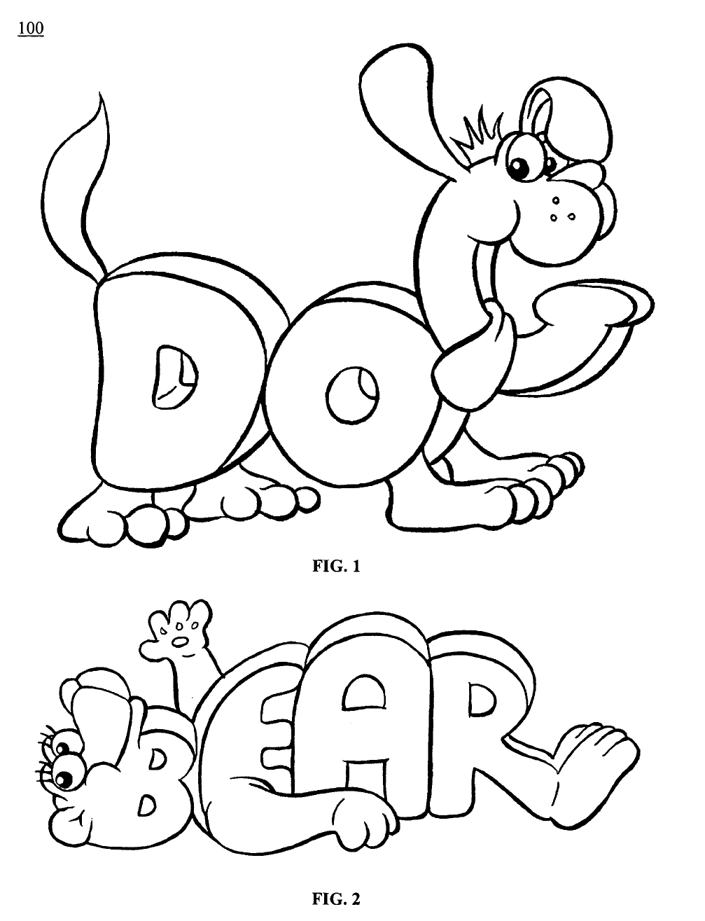

At the heart of the present invention are Word Things, a cast of characters whose shapes incorporate the letters that make up the word relating to that individual character. For example, as shown in FIG. 1, a dog's body is composed of the letters D-O-G, with a wagging tail, floppy ears and a panting tongue. In an animated version, letters come to life when they are combined to create new words, thereafter “morphing” into the actual object the word represents. In the animated version, characters interact in any suitable manner, such as getting into child-like predicaments and mishaps which they must resolve throughout each episode, typically by combining letters to make words or by changing one object to another by rearranging letters.

In all platforms, users such as children are involved in this process of word building and construction, either by actually moving the letters, such as in the on-line and toy components or through their engagement with the problem-solving activities of television characters. Through such involvement, the present invention aids in bridging letter acquisition and reading skills, thereby aiding in literacy development.

(4) Discussion

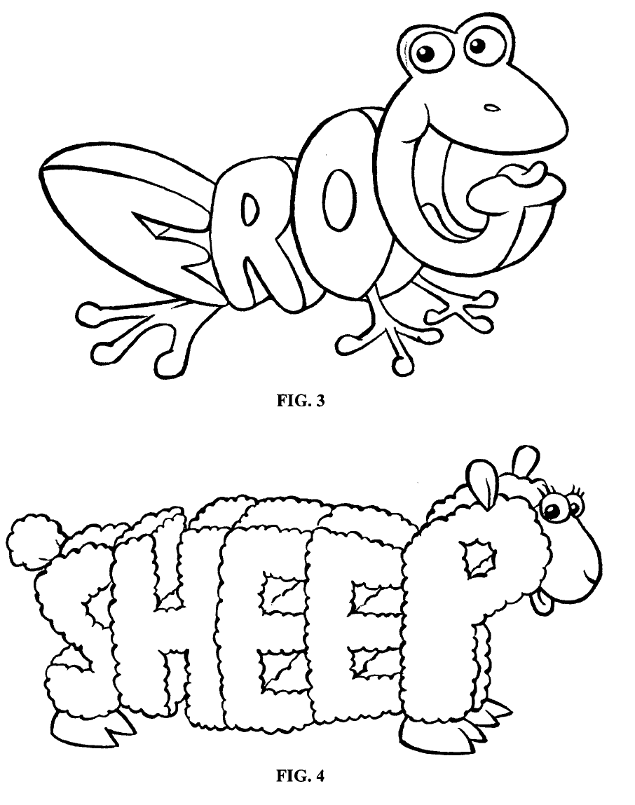

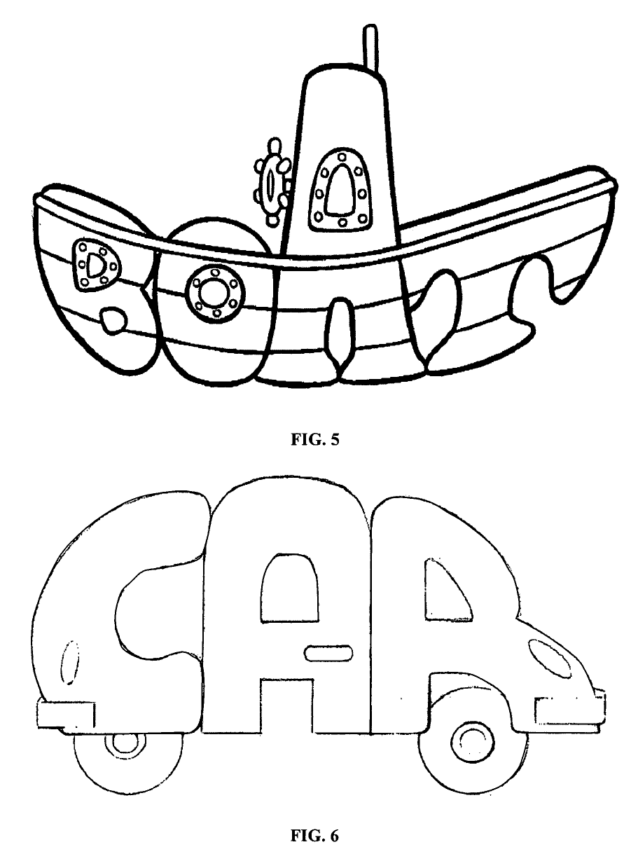

The present invention seamlessly incorporates phonetics within the context of whole-word visual representations and a stimulating storyline. Letter sounds are emphasized with the depiction of linguistic characters, such as letters, embodied in Word Things. The Word Things are a set of linguistic characters formed such that when the linguistic characters are arranged to form a word, the word forms a shape representative of an object represented by the word. By showing the letters within their composition, the Word Things (e.g. cartoon characters and objects) continually remind users of the sound of each letter in their name. For example, as shown in FIG. 2, the letter B is shown in the context of a bear, so its sound and use are integral to its appearance. Each word (such as F-R-O-G, as shown in FIG. 3) creates a visual connection for users, making letter/sound associations explicit and concrete.

The linguistic characters of the Word Things of the present invention are not limited to construction by letters and may be any suitable linguistic character for forming a word, non-limiting examples of which include Chinese characters, Japanese characters, and letters.

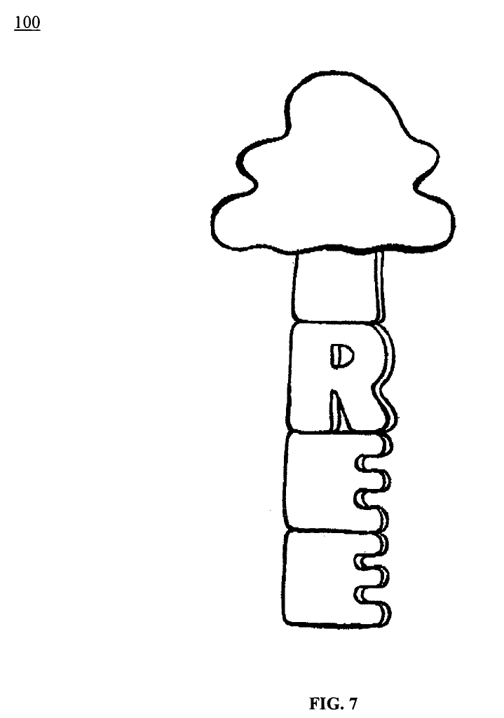

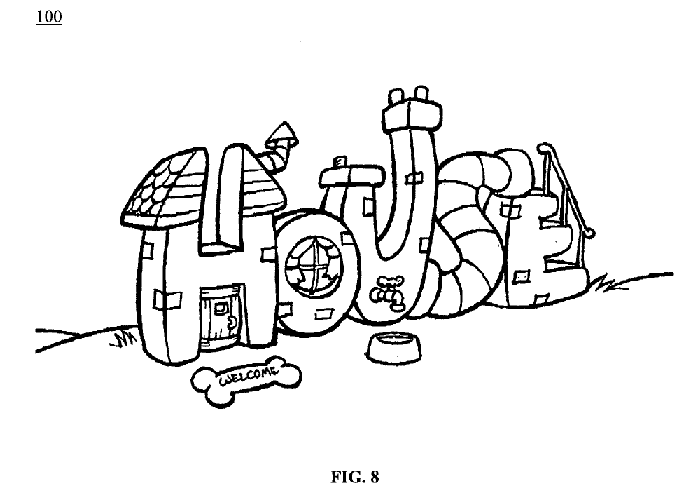

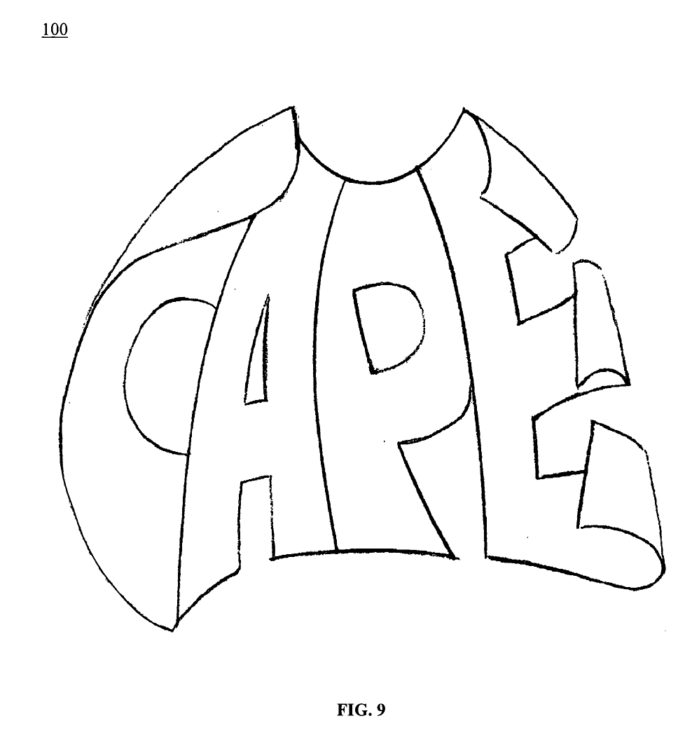

Furthermore, the Word Things are formed in any suitably recognizable shape, non-limiting examples of which include an animal, a vehicle, a plant, a dwelling, an icon, a cartoon character, and an object. FIGS. 1-4 illustrate Word Things 100 in the form of cartoon animals. As shown in FIG. 5, and 6, the Word Things 100 can also be in the form of vehicles. For further illustration, FIGS. 7, 8, 9 illustrate Word Things 100 in forms including a plant, a dwelling, and an object, respectively.

The Word Things of the present invention may be incorporated into numerous platforms and embodiments, non-limiting examples of which include a physical apparatus, a method for aiding literacy, a system, and a computer program product. Details of several embodiments are further outlined below.

(a) Apparatus

The Word Things of the present invention may be incorporated onto a physical apparatus where a set of linguistic characters is formed on a substrate.

The substrate may be any suitable substrate upon which characters can be formed, non-limiting examples of which include a book, blocks, a puzzle, and a three-dimensional toy such as a plush doll. By creating a Word Thing in an actual physical product, a user is able to touch and feel the Word Thing.

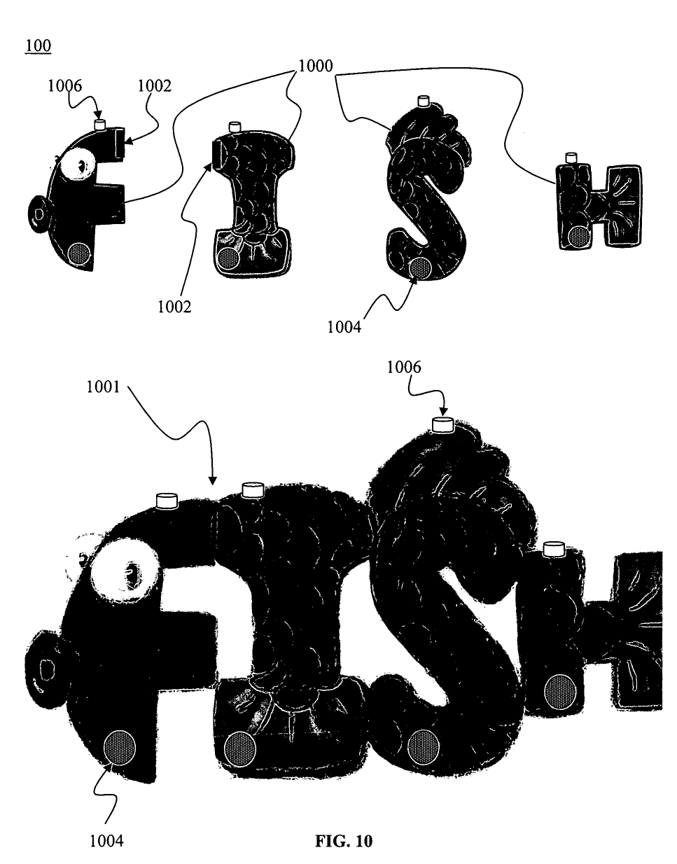

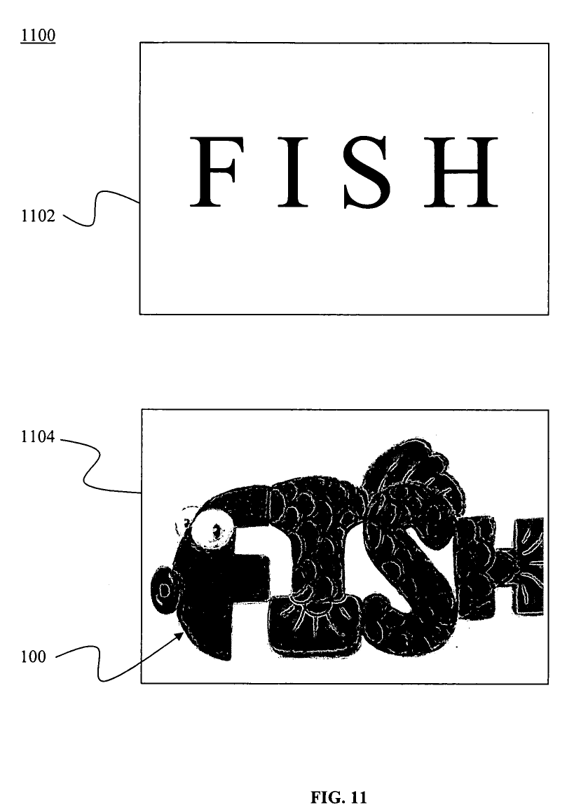

In one aspect, at least two linguistic characters in the set of linguistic characters are detachably attached with each other through a connector. In such an aspect, a user can play with the Word Thing by detaching and reattaching the linguistic characters. As shown in FIG. 10, linguistic characters 1000 of the Word Thing 100 may be separated. The linguistic characters 1000 may be re-connected 1001 through the connector 1002, the connector 1002 being any suitable mechanism, device, or configuration for connecting two objects together, non-limiting examples of which include magnets, locking shapes, Velcro, snaps, and zippers. The connector 1002 may be located at any suitable location along the linguistic character 1000, such as where the linguistic characters 1000 contact one another. Because of linguistic characters are detachably attached, children can manipulate the linguistic characters 1000 (e.g. letters) to form familiar, new or nonsensical words.

Furthermore, a sound actuator 1004 may be connected with at least one linguistic character. The sound actuator 1004 may be any suitable sound storing and reproducing device or mechanism, non-limiting examples include a memory chip attached with a speaker. An activator 1006 is operably connected with the sound actuator 1004. The activator 1006 may be any suitable mechanism or device for completing a circuit, non-limiting examples of which include a button and a switch.

The stored sound may be any applicable sound. For example, the stored sound could correspond with a sound representative of a linguistic character. As a non-limiting example of such an embodiment, actuating the activator 1006 in the letter “C,” would cause the sound actuator 1004 to produce the sound “cu,” with “cu” being representative of the letter “C.”

As another non-limiting example, when the linguistic characters are arranged to form a word, the activator 1006 is actuated to activate the means for storing and reproducing a stored sound 1004. When activated, the sound produced is any applicable sound, non-limiting examples of which include a sound being representative of the word, such as an audio version of “cat” if the word is cat; a sound being representative of a sound made by an object representative of the word, such as a “meow” if the word is cat; and a catchy theme song.

In another aspect, a Word Thing according to the present invention is printed on a substrate, such as on the surface of a book page, a flash card, or a puzzle. For example, when in a book, a Word World may be created where Word Things interact with each-other in an episode, or story line. Further, as shown in FIG. 11, the Word Things may be incorporated onto a flash card 1100. In such an embodiment, a first side 1102 of the flash card may include a word in simple text, while a second side 1104 includes a Word Thing 100. In such an aspect, a user may be aided in associated simple text with words symbolizing certain objects. Alternatively when in the form of a puzzle, the puzzle can be formed in any suitable shape or manner allowing it to be disassembled and reassembled, a non-limiting example of which includes interlocking pieces.

(b) Method

In addition to incorporating the Word Things into a physical apparatus, the present invention includes a method for making and using linguistic characters to form words (i.e. Word Things) to aid in literacy development. The method comprises forming a Word Thing, such as by forming a single linguistic character for use with another linguistic character, where the linguistic characters are formed such that when they are arranged to form a word, the word forms a shape (i.e. Word Thing) representative of an object represented by the word. The method can be applied to any user accessible format, non-limiting examples of which include television, the Internet, a computer, a toy, and print.

Having formed a Word Thing, the Word Thing can be used in a variety of formats and applications to aid in literacy development. For example, the Word Things can be incorporated into a Word World, a fictitious world where the Word Things are present and interact with each other. The Word World can be presented in numerous formats, each presentation considered an episode. Non-limiting examples of episode presentation formats include being presented in a television show, in an Internet-based interactive web-site, in a computer game (e.g. CD-ROM), and in a book.

The Word World episodes of the present invention can be produced with any suitable content and for users or audiences of any age. As a non-limiting example and as further discussed below, the Word Things and Word World episodes can be can be produced with content suitable for young children. The following discussion of Word World episodes and interactions between Word Things is for illustrative purposes only and is not intended to be limiting.

In each episode, the Word Things can be built, rearranged, and reinforced throughout the episode. The Word Things are built by using the linguistic characters (e.g., letters) to form familiar, new or nonsensical words. At the same time, users may be shown whole words and plenty of visual clues and given a compelling narrative to assist them in garnering meaning.

Through use of a Word World episode, the Word Things concretize the abstract notion of language through the use of accessible, friendly, three-dimensional characters. Each Word Thing (e.g. such as T-R-E-E as shown in FIG. 7) creates a visual connection for young viewers, making letter/sound associations explicit and concrete. By showing the letters within their composition, the characters and objects continually remind viewers of the sound of each letter in their name. For example, the letter B is shown in the context of a bear, so its sound and use are integral to its appearance.

The Word World allows children to use letters, either in toy form or on their computer, to build words just as they use blocks to build castles. As with blocks, the result is sometimes a jumble, but as letters take on more meaning for young learners, they can be combined to form real words. The reward for this growth is that the word, when on a computer or television screen, can jump to life, take the shape of the object, and solve a problem or talk to the child.

In an animated format (e.g. television show, CD-ROM, or Interactive Website), humorous mishaps occur when objects collide, connect, come apart, or otherwise gain or lose letters to form new words. Viewers are encouraged to repeat or anticipate letter sound combinations throughout these activities. Each episode may feature a “take away” word; one that is emphasized and revisited throughout the episode so that a viewer can develop a solid familiarity. For example, when Pig needs to bake a cake, he creates and combines the key ingredients: a C, A, K, and E, sounding out each letter as he forms it. Once the word is constructed, it actually takes the shape of a cake, embodying the letters, thereby forming a Word Thing. The Word Thing is then read and repeated by the characters.

The Word World tackles research-based literacy objectives within a context of a meaningful, dramatic storyline, made up of short, stand-alone scenes (i.e. episodes). An entertaining story provides a positive literary experience for children and enhances their enthusiasm for the written word. In a sample episode, characters must scramble to provide their friend Dog with a surprise birthday party when they realize they have forgotten his special day. Like all good stories, the plot has conflicts and resolution, surprises and humor, most of which involves word construction. Research has shown that offering children simple stories with a basic plot enhances their capacity to listen and understanding language (McMahon, 1996 and Cohen, Rosen, Hall & Williams, 1993). For young children, three-to five-minute scenes appropriately fit their attention span. Each Word World episode is a story composed of scenes. The scenes may be in any format, but typically follow familiar beginning-middle-end sequences. Additionally, story plots may be constructed for any age group, however, they are typically made for, and are relevant and topical to, pre-school children's experience.

Play, particularly tactile manipulation, has long been understood to promote learning. According to many theorists, such as Piaget, it is a fundamental learning tool for young children. The present invention builds play into all of its media platforms. For example, an online component of Word World may allow children to control letters and objects remotely and may reward word play activities with visual and auditory reactions.

As an alternative example, in a television show, the use of play is exemplified through the Word Things. For example, Dog and the Frog get into a tangle and their letters jumble together to form surprising non-words. In this same example, Bear saves the day by disentangling them and returning them to their original forms.

Current research indicates that children learn more when they are actively involved in the learning process, and that using their minds, bodies and voices helps to further reinforce concepts. Literary research also suggests that reading and writing skills develop simultaneously and inter-relatedly in young children, not sequentially, and that learning these skills side-by side enhances their onset. (Idaho Center on Developmental Disabilities, 1996; Teale & Sulzby, 1986).

On-line and other computer application components will provide ample opportunities for interactivity, allowing children to play and solve problems by moving letters and letter sounds. This technology is particularly well suited for a constructionist approach to learning, which posits that children learn best by interacting with objects, effecting change, and developing their own theoretic framework.

Additionally, a web site may include educational suggestions and information for adults, where parents, caregivers and educators can learn more about the Word World approach to literacy. Involving adults in the learning process fosters social interaction, which further enhances learning.

Toys and online platforms are inherently interactive, but a Word World television show uses similar techniques to involve users (e.g., children) while viewing. Children remain actively engaged in the learning process because, as audience members, they are asked to participate. They are needed to help solve problems posed by Word Things or to support characters by calling out letters. For example, when the pancake gets cut into two pieces, a home audience helps Sheep find the Pan and the Cake so she can put them back together again.

The Word World of the present invention may include a cast of regular characters (i.e., Word Things) that include a variety of species, each with his/her own personality, skill set, and quirky habits. Learning to work together and utilize one-another's strengths is central to the plot of each episode. In the course of each episode, the characters share, take turns, negotiate, compromise and collaborate. These important pro-social skills are not layered on top of a story, but instead are integral to a storyline, serving as tools that resolve dramatic tension. Characters confront age-appropriate problems and must work together to come up with solutions and solve conflicts.

An implicit message in each episode is that words play an important role in people's lives and can be used as problem-solving tools. Word World characters construct or reconfigure words to solve physical problems. For example, when the Word Things, while traveling by BUS, arrive at the edge of the river with no discernable way to cross it they decide to switch the letters around, turning their BUS into a SUB, which they use to travel beneath the water to the other side.

In Word World, words mend social as well as physical problems. Since the solution to most young children's social conflicts exists in the use of language and verbal expression, young viewers are shown how to identify their feelings, label those emotions, and express them in words.

The stories in Word World episodes follow an unhurried, steady pace, appropriate for preschool viewers' attention, comprehension and concept retention. The visual imagery and language are kept simple and clear, so that preschool children can easily follow along. A take-away word is emphasized throughout the episode to reinforce learning and a karaoke recap near the end of each episode provides a chance for young viewers to revisit key words, which are visually highlighted in a short narrative. The karaoke recap is a song where the key words are sung and viewers are encouraged to sing along to further reinforce learning of the key words.

Such reinforcement can also be carried out through a build a word song. The build a word song is configured to correspond with the particular episode in which the build a word song is played. As a non-limiting example, at the beginning of each episode, a quest may be laid out (such as “we need to make a hat,” or “we need to set up this birthday party”). After the quest is laid out, a “build a word” song is played which conveys the essential philosophy of Word World, that all objects are constructed of a word, with one verse changing to suit the content of that particular episode. When any problem needs to be solved, the Word Things may repeat the “build a word” song as applicable to that episode.

Children's responses to characters greatly impact their appreciation for all media platforms, their willingness to engage in activities and their product purchase decisions. Word Things fit a profile of successful characters: each animal has distinct, clear, endearing, identifiable features; each has unique, humorous and child-like personality traits; and collectively they grapple with conflicts and behaviors that are likely to resonate with the target audience.

For example, Pig fancies himself a great chef with his own cooking show, and frequently demonstrates culinary techniques to an imaginary audience. Bear, an insatiable adventurer and leader, uses any means available to find solutions and express her creativity. Her seemingly boundless enthusiasm and passion is only hindered when she runs out of steam and needs to sleep.

As discussed above, the Word World episodes can be produced in a variety of formats, utilizing a variety of content. Following is further discussion of a system incorporating the above method, and a computer program product (e.g., computer game).

(c) Data Processing System

The present invention also comprises a system for using linguistic characters to form words to aid in literacy development. Through use of the data processing system, the Word Things and their Word World episodes can be incorporated into an interactive Web-site. The Web-site allows users to access it over the Internet so that users can interact with a Word World as described above. Alternatively, the system can be loaded onto a home computer where a user interacts with their home computer to access and manipulate the Word World.

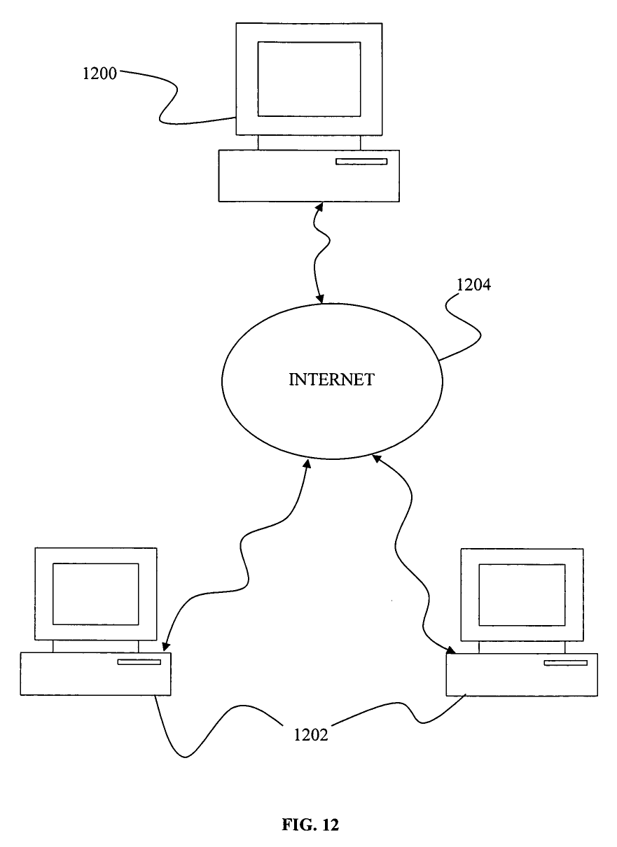

FIG. 12 illustrates a data processing system 1200 (e.g., server computer) incorporating the operations of the method described above. The method utilizes the data processing system 1200 for storing computer executable instructions for causing a processor to carry out the operations. The data processing system 1200 may be accessible by a user's computer 1202 over the Internet 1204 through an Internet-accessing user interface (e.g., web page).

In another aspect, the computer executable instructions for causing a processor to carry out the operations of the method can be loaded onto the user's computer 1202. In this aspect, the user's computer 1202 functions as the data processing system 1200.

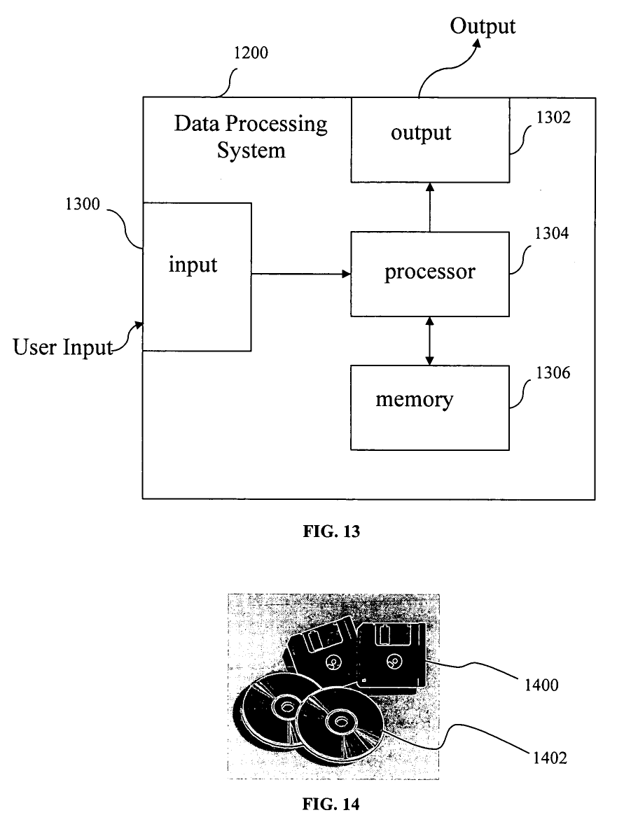

A block diagram depicting the components of the data processing system 1200 used in the present invention is provided in FIG. 13. The data processing system 1200 comprises an input 1300 for receiving information from a user.

Information received may include input such as selecting a Word Thing to interact with another Word thing, from devices such as scanners, keypads, keyboards, mic, other peripherals such as storage devices, other programs, etc. The input 1300 may include multiple “ports.” An output 1302 is connected with the processor for providing information for transmission to other data processing systems, to storage devices, to display devices such as monitors, to generating information necessary for delivery, and to other mechanisms for presentation in user-readable forms. Output may also be provided to other devices or other programs, e.g., to other software modules, for use therein. The input 1300 and the output 1302 are both coupled with a processor 1304, which may be a general-purpose computer processor or a specialized processor designed specifically for use with the present invention. The processor 1304 is coupled with a memory 1306 to permit storage of data and software to be manipulated by commands to the processor.

(d) Computer Program Product

An illustrative diagram of a computer program product embodying the present invention is depicted in FIG. 14. As a non-limiting example, the computer program product is depicted as either a floppy disk 1400 or an optical disk 1402. However, as mentioned previously, the computer program product generally represents computer-readable code stored on any compatible computer-readable medium for causing a processor to carry out the operations of the above described method.

(5) Conclusion

In conclusion, the present invention provides a unique technique for aiding in literacy development. The technique includes an apparatus, method, system, and computer program product using Word Things to build on a foundation of language development and bring users (e.g., children) toward a world of literacy. The Word Things are comprised of a set of linguistic characters formed such that when the linguistic characters are arranged to form a word, the word forms a shape representative of an object represented by the word. The Word Things interact in a Word World environment, making letters, phonics and words come alive in a new and unique way by giving them a physicality that enhances appeal and comprehension.

1. An apparatus for aiding in literacy development, the apparatus comprising a set of linguistic characters formed such that when the linguistic characters are arranged to form a word, the word forms a shape representative of an object represented by the word; thereby assisting a user in bridging letter acquisition and reading skills, thereby aiding in literacy development.

2. An apparatus as set forth in claim 1, wherein the linguistic characters are selected from a group consisting of Chinese characters, Japanese characters, and letters to be used in forming words.

3. An apparatus as set forth in claim 2, wherein the shape formed is a shape selected from a group consisting of an animal, a plant, a vehicle, a dwelling, an icon, a cartoon character, and an object.

4. An apparatus as set forth in claim 3, wherein the set of linguistic characters is formed on a substrate, and where the substrate is selected from a group consisting of a book, blocks, a puzzle, a toy, and a multi-sided flash card.

5. An apparatus as set forth in claim 4, further comprising a connector attached with a linguistic character, such that at least two linguistic characters in the set of linguistic characters are detachably attached with each other through the connector.

6. An apparatus as set forth in claim 5, wherein the connector is selected from a group consisting of magnets, locking shapes, Velcro, snaps, and zippers.

7. An apparatus as set forth in claim 6, further comprising a sound actuator connected with at least one linguistic character in the set of linguistic characters, and a activator operably connected with the sound actuator to produce a stored sound.

8. An apparatus as set forth in claim 7, wherein the stored sound corresponds with a sound representative of the at least one linguistic character.

9. An apparatus as set forth in claim 8, wherein when the linguistic characters are arranged to form a word, the activator the sound actuator is actuated to activate the means for storing and reproducing a stored sound, wherein the stored sound is a sound selected from a group consisting of a sound being representative of the word, a sound being representative of a sound made by an object representative of the word, and a theme song.

10. An apparatus as set forth in claim 1, further comprising a sound actuator connected with at least one linguistic character in the set of linguistic characters, and a activator operably connected with the sound actuator to produce a stored sound.

11. An apparatus as set forth in claim 10, wherein the stored sound corresponds with a sound representative of the at least one linguistic character.

12. An apparatus as set forth in claim 10, wherein when the linguistic characters are arranged to form a word, the activator the sound actuator is actuated to activate the means for storing and reproducing a stored sound, wherein the stored sound is a sound selected from a group consisting of a sound being representative of the word, a sound being representative of a sound made by an object representative of the word, and a theme song.

13. An apparatus as set forth in claim 1, wherein the set of linguistic characters is formed on a substrate, and where the substrate is selected from a group consisting of a book, blocks, a puzzle, a toy, and a multi-sided flash card.

14. An apparatus as set forth in claim 1, further comprising a connector attached with a linguistic character, such that at least two linguistic characters in the set of linguistic characters are detachably attached with each other through the connector.

15. An apparatus as set forth in claim 14, wherein the connector is selected from a group consisting of magnets, locking shapes, Velcro, snaps, and zippers.

16. An apparatus as set forth in claim 1, wherein the shape formed is a shape selected from a group consisting of an animal, a plant, a vehicle, a dwelling, an icon, a cartoon character, and an object.

17. A method for making linguistic character based shapes to aid in literacy development, comprising an act of:
forming a plurality of linguistic characters in a particular shape such that when the plurality of linguistic characters are arranged alongside each other to form a word, the word forms a shape representative of an object represented by the word; thereby assisting a user in bridging letter acquisition and reading skills, thereby aiding in literacy development.

18. A method for making linguistic character based shapes as set forth in claim 17, wherein the act of forming a single linguistic character, further comprises an act of selecting a linguistic character from a group consisting of Chinese characters, Japanese characters, and letters to be used in forming words.

19. A method for making linguistic character based shapes as set forth in claim 18, wherein the act of forming a single linguistic character further comprises an act of forming a shape, the shape selected from a group consisting of an animal, a plant, a vehicle, a dwelling, a cartoon character, and an object.

20. A method for making linguistic character based shapes as set forth in claim 17, wherein the act of forming a single linguistic character further comprises an act of forming a shape, the shape selected from a group consisting of an animal, a plant, a vehicle, a dwelling, a cartoon character, and an object.

21. A method for using linguistic characters to form words to aid in literacy development, comprising an act of:
forming a word thing by forming a plurality of linguistic characters in a particular shape such that when the plurality of linguistic characters are arranged alongside each other to form a word, the word forms a shape representative of an object represented by the word; thereby assisting a user in bridging letter acquisition and reading skills, thereby aiding in literacy development.

22. A method for using linguistic characters as set forth in claim 21, wherein the act forming a word thing by forming a plurality of linguistic characters in a particular shape, further comprises an act of selecting linguistic characters from a group consisting of Chinese characters, Japanese characters, and letters to be used in forming words.

23. A method for using linguistic characters as set forth in claim 22, wherein when the word forms a shape, the shape is selected from a group consisting of an animal, a plant, a vehicle, a dwelling, a cartoon character, and an object.

24. A method for using linguistic characters as set forth in claim 23, further comprising an act of generating a Word World episode, the Word World episode being a fictitious environment where at least one word thing is present.

25. A method for using linguistic characters as set forth in claim 24, wherein in the act of generating a Word World episode, the episode is a narrative that relates an event and forms a coherent story in itself.

26. A method for using linguistic characters as set forth in claim 25, wherein in the act of generating a Word World episode, the episode is generated in a format selected from a group consisting of a television show story line, a book story line, a computer game story line, a puzzle pictorial, and an Internet-based interactive web-site story line.

27. A method for using linguistic characters as set forth in claim 26, further comprising an act of generating visual clues and a narrative to assist the user in garnering a meaning of the word thing.

28. A method for using linguistic characters as set forth in claim 27, wherein in the act of generating a Word World episode, the episode is an animated episode where the word things are animated and take the shape of an object.

29. A method for using linguistic characters as set forth in claim 28, wherein the act of generating a Word World episode further comprises an act of generating a problem in the episode, where the word things interact with each other to solve the problem.

30. A method for using linguistic characters as set forth in claim 29, wherein the act of generating a Word World episode further comprises an act of encouraging viewers to help solve the problem by encouraging the viewer to call out letters.

31. A method for using linguistic characters as set forth in claim 30, wherein in the act of generating a Word World episode, the word things construct and reconfigure words to solve the problem.

32. A method for using linguistic characters as set forth in claim 31, wherein in the act of generating a Word World episode, the episode is provided for a duration of time, the duration of time being from approximately one minute to thirty minutes.

33. A method for using linguistic characters as set forth in claim 32, wherein the act of generating a Word World episode further comprises an act of generating a take-away word, the take-away word being a word that is emphasized and revisited throughout the episode so that a viewer can develop a solid familiarity with the take-away word.

34. A method for using linguistic characters as set forth in claim 33, wherein the act of generating a Word World episode further comprises an act of generating a karaoke recap near the end of each episode, thereby providing a chance for viewers to revisit key words, which are visually highlighted in the karaoke recap.

35. A method for using linguistic characters as set forth in claim 34, wherein the act of generating a Word World episode further comprises an act of generating a story line where the word things collide, connect, come apart, and gain or lose letters to form new words.

36. A method for using linguistic characters as set forth in claim 35, wherein the act of generating a Word World episode further comprises an act encouraging viewers to repeat letter sound combinations.

37. A method for using linguistic characters as set forth in claim 36, further comprising an act of recording the Word World episode.

38. A method for using linguistic characters as set forth in claim 37, further comprising an act of broadcasting the Word World episode.

39. A method for using linguistic characters as set forth in claim 38, wherein the act of generating a Word World episode further comprises an act of generating a build a word song, the build a word song corresponding to contents of a particular episode in which the build a word song is generated.

40. A method for using linguistic characters as set forth in claim 21, further comprising an act of generating a Word World episode, the Word World episode being a fictitious environment where at least one word thing is present.

41. A method for using linguistic characters as set forth in claim 40, wherein in the act of generating a Word World episode, the episode is a narrative that relates an event and forms a coherent story in itself.

42. A method for using linguistic characters as set forth in claim 40, wherein in the act of generating a Word World episode, the episode is generated in a format selected from a group consisting of a television show story line, a book story line, a computer game story line, a puzzle pictorial, and an Internet-based interactive web-site story line.

43. A method for using linguistic characters as set forth in claim 40, wherein in the act of generating a Word World episode, the episode is an animated episode where the word things are animated and take the shape of an object.

44. A method for using linguistic characters as set forth in claim 40, wherein the act of generating a Word World episode further comprises an act of generating a problem in the episode, where the word things interact with each other to solve the problem.

45. A method for using linguistic characters as set forth in claim 44, wherein the act of generating a Word World episode further comprises an act of encouraging viewers to help solve the problem by encouraging the viewer to call out letters.

46. A method for using linguistic characters as set forth in claim 44, wherein in the act of generating a Word World episode, the word things construct and reconfigure words to solve the problem.

47. A method for using linguistic characters as set forth in claim 40, wherein in the act of generating a Word World episode, the episode is provided for a duration of time, the duration of time being from approximately one minute to thirty minutes.

48. A method for using linguistic characters as set forth in claim 40, wherein the act of generating a Word World episode further comprises an act of generating a take-away word, the take-away word being a word that is emphasized and revisited throughout the episode so that a viewer can develop a solid familiarity with the take-away word.

49. A method for using linguistic characters as set forth in claim 40, wherein the act of generating a Word World episode further comprises an act of generating a karaoke recap near the end of each episode, thereby providing a chance for viewers to revisit key words, which are visually highlighted in the karaoke recap.

50. A method for using linguistic characters as set forth in claim 40, wherein the act of generating a Word World episode further comprises an act of generating a story line where the word things collide, connect, come apart, and gain or lose letters to form new words.

51. A method for using linguistic characters as set forth in claim 40, wherein the act of generating a Word World episode further comprises an act encouraging viewers to repeat letter sound combinations.

52. A method for using linguistic characters as set forth in claim 40, further comprising an act of recording the Word World episode.

53. A method for using linguistic characters as set forth in claim 40, further comprising an act of broadcasting the Word World episode.

54. A method for using linguistic characters as set forth in claim 40, wherein the act of generating a Word World episode further comprises an act of generating a build a word song, the build a word song corresponding to contents of a particular episode in which the build a word song is generated.

55. A method for using linguistic characters as set forth in claim 21, further comprising an act of generating visual clues and a narrative to assist the user in garnering a meaning of the word thing.

56. A method for using linguistic characters as set forth in claim 21, wherein when the word forms a shape, the shape is selected from a group consisting of an animal, a plant, a vehicle, a dwelling, a cartoon character, and an object.

57. A data processing system for manipulating linguistic characters to aid in literacy development, comprising:
a processor with an input, an output, and a memory, the processor configured to receive a user input from the input and to process data from the memory and input from a user, where the data includes a word thing, the word thing being a word comprised of a plurality of linguistic characters formed such that when the linguistic characters are arranged to form the word, the word forms a shape representative of an object represented by the word, and where in processing the data based on the user input, the processor causes a manipulation of a previous representation of the word thing such that a user can manipulate visual representations of the word thing, the output connected with the processor for receiving graphical a representation of the word thing and for transmitting the graphical representation for display on a visual display device, thereby permitting the user to view the word thing and rearrange the word thing such that it forms a word where the word has a shape representative of a meaning of the word.

58. A data processing system as set forth in claim 57, wherein the input is an Internet accessible input, allowing users to interact with the system over the Internet.

59. A data processing system as set forth in claim 58, wherein the processor further includes computer executable instructions for causing the processor to generate solvable problems and for allowing users to solve the solvable problems by moving the linguistic characters.

60. A data processing system as set forth in claim 59, wherein the linguistic characters are selected from a group consisting of Chinese characters, Japanese characters, and letters to be used in forming words.

61. A data processing system as set forth in claim 60, wherein the word thing is selected from a group consisting of an animal, a plant, a vehicle, a dwelling, a cartoon character, and an object.

62. A data processing system as set forth in claim 61, wherein the processor further includes computer executable instructions for causing the processor to generate a Word World, the Word World being an animated environment where at least one word thing is present.

63. A data processing system as set forth in claim 62, wherein the Word World is generated as a Word World episode, the episode being a narrative that relates an event and forms a coherent story in itself.

64. A data processing system as set forth in claim 63, wherein the Word World episode is generated as an Internet-based interactive web-site story line.

65. A data processing system as set forth in claim 64, wherein the processor further includes computer executable instructions for causing the processor to generate visual clues and a narrative to assist the user in garnering a meaning of the word thing.

66. A data processing system as set forth in claim 65, wherein the processor further includes computer executable instructions for causing the processor to generate a problem in the episode, where the word things interact with each other to solve the problem.

67. A data processing system as set forth in claim 66, wherein the processor further includes computer executable instructions for causing the processor to encourage a user to help solve the problem by encouraging the user to call out letters.

68. A data processing system as set forth in claim 67, wherein the processor further includes computer executable instructions for causing the processor to allow a user to construct and reconfigure words to solve the problem.

69. A data processing system as set forth in claim 68, wherein the processor further includes computer executable instructions for causing the processor to generate a take-away word, the take-away word being a word that is emphasized and revisited throughout the episode so that a viewer can develop a solid familiarity with the take-away word.

70. A data processing system as set forth in claim 69, wherein the processor further includes computer executable instructions for causing the processor to generate a karaoke recap near the end of each episode, thereby providing a chance for viewers to revisit key words, which are visually highlighted in the karaoke recap.

71. A data processing system as set forth in claim 70, wherein the processor further includes computer executable instructions for causing the processor to generate a story line where the word things collide, connect, come apart, and gain or lose letters to form new words.

72. A data processing system as set forth in claim 71, wherein the processor further includes computer executable instructions for causing the processor to encourage viewers to repeat letter sound combinations.

73. A data processing system as set forth in claim 72, wherein the processor further includes computer executable instructions for causing the processor to generate educational suggestions and information for adults, where parents, caregivers and educators can learn more about the Word World.

74. A data processing system as set forth in claim 73, wherein the processor further includes computer executable instructions for causing the processor to generate a build a word song, the build a word song corresponding to contents of a particular episode in which the build a word song is generated.

75. A data processing system as set forth in claim 57, wherein the processor further includes computer executable instructions for causing the processor to generate a Word World, the Word World being an animated environment where at least one word thing is present.

76. A data processing system as set forth in claim 75, wherein the Word World is generated as a Word World episode, the episode being a narrative that relates an event and forms a coherent story in itself.

77. A data processing system as set forth in claim 76, wherein the processor further includes computer executable instructions for causing the processor to generate a build a word song, the build a word song corresponding to contents of a particular episode in which the build a word song is generated.

78. A data processing system as set forth in claim 76, wherein the Word World episode is generated as an Internet-based interactive web-site story line.

79. A data processing system as set forth in claim 76, wherein the processor further includes computer executable instructions for causing the processor to generate a take-away word, the take-away word being a word that is emphasized and revisited throughout the episode so that a viewer can develop a solid familiarity with the take-away word.

80. A data processing system as set forth in claim 76, wherein the processor further includes computer executable instructions for causing the processor to generate a karaoke recap at the end of each Word World episode, thereby providing a chance for viewers to revisit key words, which are visually highlighted in the karaoke recap.

81. A data processing system as set forth in claim 76, wherein the processor further includes computer executable instructions for causing the processor to generate educational suggestions and information for adults, where parents, caregivers and educators can learn more about the Word World.

82. A data processing system as set forth in claim 57, wherein the processor further includes computer executable instructions for causing the processor to generate a solvable problem and for allowing users to solve the solvable problem by manipulating the linguistic characters.

83. A data processing system as set forth in claim 82, wherein the processor further includes computer executable instructions for causing the processor to encourage a user to help solve the problem by encouraging the user to call out letters.

84. A data processing system as set forth in claim 82, wherein the processor further includes computer executable instructions for causing the processor to allow a user to construct and reconfigure words to solve the problem.

85. A data processing system as set forth in claim 57, wherein the processor further includes computer executable instructions for causing the processor to generate visual clues and a narrative to assist the user in garnering a meaning of the word thing.

86. A data processing system as set forth in claim 57, wherein the processor further includes computer executable instructions for causing the processor to generate a story line where the word things collide, connect, come apart, and gain or lose letters to form new words.

87. A data processing system as set forth in claim 57, wherein the processor further includes computer executable instructions for causing the processor to encourage viewers to repeat letter sound combinations.

88. A data processing system as set forth in claim 57, wherein the linguistic characters are selected from a group consisting of Chinese characters, Japanese characters, and letters to be used in forming words.

89. A data processing system as set forth in claim 57, wherein the word thing is selected from a group consisting of an animal, a plant, a vehicle, a dwelling, a cartoon character, and an object.

90. A computer program product for making linguistic character based shapes, the computer program product comprising computer-readable instructions encoded on a computer-readable medium for causing a computer to perform an operation of generating a word thing comprised of a plurality of linguistic characters, the linguistic characters generated such that when the characters are arranged to form a word, the word forms a shape representative of an object represented by the word; thereby assisting a user in bridging letter acquisition and reading skills, thereby aiding in literacy development.

91. A computer program product as set forth in claim 90, wherein the plurality of linguistic characters are linguistic characters selected from a group consisting of Chinese characters, Japanese characters, and letters to be used in forming words.

92. A computer program product as set forth in claim 91, wherein the shape is selected from a group consisting of an animal, a plant, a vehicle, a dwelling, a cartoon character, and an article.

93. A computer program product as set forth in claim 92, further comprising a means for manipulating the linguistic characters to form a word thing.

94. A computer program product as set forth in claim 93, further comprising a means for generating solvable problems and for allowing users to solve the solvable problems by moving the linguistic characters.

95. A computer program product as set forth in claim 94, further comprising a means for generating a Word World, the Word World being an animated environment where at least one word thing is present.

96. A computer program product as set forth in claim 95, wherein the Word World is generated as a Word World episode, the episode being a narrative that relates an event and forms a coherent story in itself.

97. A computer program product as set forth in claim 96, further comprising a means for generating visual clues and a narrative to assist a user in garnering a meaning of the word thing.

98. A computer program product as set forth in claim 97, further comprising a means for generating a problem in the episode, where the word things interact with each other to solve the problem.

99. A computer program product as set forth in claim 98, further comprising a means for encouraging a user to help solve the problem by encouraging the user to call out letters.

100. A computer program product as set forth in claim 99, further comprising a mean for allowing a user to construct and reconfigure words to solve the problem.

101. A computer program product as set forth in claim 100, further comprising a means for generating a take-away word, the take-away word being a word that is emphasized and revisited throughout the episode so that a user can develop a solid familiarity with the take-away word.

102. A computer program product as set forth in claim 101, further comprising a means for generating a karaoke recap near the end of each episode, thereby providing a chance for user to revisit key words, which are visually highlighted in the karaoke recap.

103. A computer program product as set forth in claim 102, further comprising a means for generating a story line where the word things collide, connect, come apart, and gain or lose letters to form new words.

104. A computer program product as set forth in claim 103, further comprising a means for encouraging viewers to repeat letter sound combinations.

105. A computer program product as set forth in claim 104, further comprising a means for generating educational suggestions and information for adults, where parents, caregivers and educators can learn more about the Word World.

106. A computer program product as set forth in claim 105, further comprising a means for generating a build a word song, the build a word song corresponding to contents of a particular episode in which the build a word song is generated.

107. A computer program product as set forth in claim 90, further comprising a means for generating a Word World, the Word World being an animated environment where at least one word thing is present.

108. A computer program product as set forth in claim 107, wherein the Word World is generated as a Word World episode, the episode being a narrative that relates an event and forms a coherent story in itself.

109. A computer program product as set forth in claim 108, further comprising a means for generating a take-away word, the take-away word being a word that is emphasized and revisited throughout the episode so that a user can develop a solid familiarity with the take-away word.

110. A computer program product as set forth in claim 108, further comprising a means for generating a karaoke recap near the end of each episode, thereby providing a chance for user to revisit key words, which are visually highlighted in the karaoke recap.

111. A computer program product as set forth in claim 108, further comprising a means for generating educational suggestions and information for adults, where parents, caregivers and educators can learn more about the Word World.

112. A computer program product as set forth in claim 108, further comprising a means for generating a build a word song, the build a word song corresponding to contents of a particular episode in which the build a word song is generated.

113. A computer program product as set forth in claim 108, further comprising a means for generating a problem in the episode, where the word things interact with each other to solve the problem.

114. A computer program product as set forth in claim 113, further comprising a mean for encouraging a user to help solve the problem by encouraging the user to call out letters.

115. A computer program product as set forth in claim 113, further comprising a mean for allowing a user to construct and reconfigure words to solve the problem.

116. A computer program product as set forth in claim 90, wherein the shape is selected from a group consisting of an animal, a plant, a vehicle, a dwelling, a cartoon character, and an article.

117. A computer program product as set forth in claim 90, further comprising a means for manipulating the linguistic characters to form a word thing.

118. A computer program product as set forth in claim 90, further comprising a means for generating solvable problems and for allowing users to solve the solvable problems by moving the linguistic characters.

119. A computer program product as set forth in claim 90, further comprising means for generating visual clues and a narrative to assist a user in garnering a meaning of the word thing.

120. A computer program product as set forth in claim 90, further comprising a means for generating a story line where the word things collide, connect, come apart, and gain or lose letters to form new words.

121. A computer program product as set forth in claim 90, further comprising a means for encouraging viewers to repeat letter sound combinations.
